(19) United States
(12) Patent Application Publication
(10) Pub. No.: US 2026/0087851 A1
(43) Pub. Date: Mar. 26, 2026

(54) METHOD AND SYSTEM FOR RECOGNIZING WANDERING BEHAVIOR OF PEDESTRIAN BASED ON MOTION TRAJECTORY

(71) Applicant: Tongji University, Shanghai (CN)

(72) Inventors: Rongyong Zhao, Shanghai (CN); Wenjie Zhu, Shanghai (CN); Chuanfeng Han, Shanghai (CN); Bingyu Wei, Shanghai (CN); Hao Zhang, Shanghai (CN); Cuiling Li, Shanghai (CN); Yunlong Ma, Shanghai (CN)

(21) Appl. No.: 19/052,341

(22) Filed: Feb. 13, 2025

Related U.S. Application Data
(63) Continuation of application No. PCT/CN2025/072902, filed on Jan. 17, 2025.

(30) Foreign Application Priority Data
Sep. 26, 2024 (CN) 202411352553.3

(51) Int. Cl. G06V 40/20; G06T 7/246; G06V 20/52

(52) U.S. Cl. CPC G06V 40/20; G06T 7/248; G06V 20/52; G06T 2207/30241

(57) ABSTRACT

A method for recognizing a wandering behavior of a pedestrian based on a motion trajectory includes: acquiring motion images of the pedestrian, recognizing motion centroids of the pedestrian based on the motion images, and constructing the motion trajectory of the pedestrian according to the motion centroids; and performing, according to pedestrian wandering behavior criteria, a wandering behavior recognition on the motion trajectory of the pedestrian to obtain a recognition result. Construction steps of the pedestrian wandering behavior criteria include: drawing, according to common wandering behaviors in public places, wandering motion trajectories appeared in different scenes; and analyzing wandering motion trajectories appeared in the different scenes to obtain the pedestrian wandering behavior criteria. The method considers the wandering motion trajectories in the different scenes, thereby improving pertinence of recognizing the wandering behavior of the pedestrian.

### CROSS-REFERENCE TO RELATED APPLICATIONS

This application is a continuation of International Patent Application No. PCT/CN2025/072902, filed Jan. 17, 2025, which claims the priority of Chinese Patent Application No. 202411352553.3, filed Sep. 26, 2024, both of which are herein incorporated by reference in their entirety.

### TECHNICAL FIELD

The disclosure relates to the field of population stability analysis, and more particularly to a method and a system for recognizing a wandering behavior of a pedestrian based on a motion trajectory.

### BACKGROUND

With the improvement of the coverage of network surveillance cameras in public places, video and image data have become abundant, and computer vision technology for human behavior recognition has also been fully developed and widely applied. Scholars at home and abroad have been studying crowd evacuation and emergency events since the early 20th century. In various sudden accidents in the public places, pedestrians are easily influenced by environment and fall into a state of panic, which can then trigger various panic behaviors.

At present, there are still some deficiencies in related research. On one hand, at present, research on wandering motion trajectories of the pedestrians does not consider different wandering motion modes in different scenes. For example, a patent application CN114662521A discloses a pedestrian wandering behavior detection method and system, including: obtaining a video compressed code stream of a detection region, and extracting the multi-frame image data contained in the video compressed code stream; obtaining a pre-trained neural network model, and inputting the image data into the neural network model frame by frame to generate a coordinate set which is composed of multiple target detection frame coordinates and is used for representing a target moving path; and performing rollback detection of the target in a single direction based on the coordinate set, and if a number of rollback times exceeds a threshold value, outputting a detection result that the target has a wandering behavior. This method does not consider the different wandering motion modes in the different scenes, and lacks a more targeted wandering behavior criterion based on a motion trajectory. On the other hand, the existing researches in the related art on disturbance propagation of panic crowd based on computer vision are mostly based on crowd flow or density information. There is less research that extracts dynamic characteristics such as the motion trajectory, velocity, or acceleration from video image data for disturbance propagation analysis.

### SUMMARY

In order to overcome the deficiencies of the existing technology in the related art, the disclosure provides a method and a system for recognizing a wandering behavior of a pedestrian based on a motion trajectory thereby achieving accurate recognition of the wandering behavior of the pedestrian.

A purpose of the disclosure can be achieved through the following technical solutions.

A method for recognizing a wandering behavior of a pedestrian based on a motion trajectory, including:
acquiring motion images of the pedestrian, recognizing motion centroids of the pedestrian based on the motion images, and constructing the motion trajectory of the pedestrian according to the motion centroids; and
performing, according to pedestrian wandering behavior criteria, a wandering behavior recognition on the motion trajectory of the pedestrian to obtain a recognition result;
where construction steps of the pedestrian wandering behavior criteria include:
   drawing, according to common wandering behaviors in public places, wandering motion trajectories appeared in different scenes; and
   analyzing the wandering motion trajectories appeared in the different scenes to obtain the pedestrian wandering behavior criteria.

In an embodiment, the recognizing motion centroids of the pedestrian based on the motion images, and constructing the motion trajectory of the pedestrian according to the motion centroids includes:
obtaining, based on the motion images of the pedestrian, key nodes of the pedestrian to form different body segments, and calculating a centroid of each body segment of the different body segments;
calculating total centroids of the pedestrian as the motion centroids of the pedestrian by using the centroid of each body segment of the different body segments; and
fitting coordinates of the total centroids of the pedestrian in a period time according to a time sequence, to thereby obtain a motion trajectory of the total centroids of the pedestrian as the motion trajectory of the pedestrian in the period of time.

In an embodiment, the key nodes of the pedestrian include: a head, a left ear, a right ear, a left eye, a right eye, a nose, a left mouth corner, a right mouth corner, a neck, a left shoulder, a right shoulder, a left elbow, a right elbow, a left wrist, a right wrist, a left hip, a right hip, a left knee, a right knee, a left ankle and a right ankle.

In an embodiment, a calculation formula of the centroid of each body segment of the different body segments is as follows:

$${x}_{k} = {x}_{p} {l}_{p} + {x}_{d} {l}_{d} \\ {y}_{k} = {y}_{p} {l}_{p} + {y}_{d} {l}_{d} \\ {z}_{k} = {z}_{p} {l}_{p} + {z}_{d} {l}_{d}$$

where (xₖ, yₖ, zₖ) represents coordinates of the centroid of each body segment of the different body segments, (xₚ, yₚ, zₚ) represents coordinates of a proximal end of each body segment of the different body segments, (x_{d}, y_{d}, z_{d}) represents coordinates of a distal end of each body segment of the different body segments, lₚ represents a weighting coefficient for the coordinates of the proximal end of each body segment of the different body segments, and l_{d} represents a weighting coefficient for the coordinates of the distal end of each body segment of the different body segments.

In an embodiment, a calculation formula of each of the total centroids of the pedestrian is as follows:

$${x}_{c} = \frac{{\sum }_{k = 1}^{13} {m}_{k} {x}_{k}}{M} \\ {y}_{c} = \frac{{\sum }_{k = 1}^{13} {m}_{k} {y}_{k}}{M} \\ {z}_{c} = \frac{{\sum }_{k = 1}^{13} {m}_{k} {z}_{k}}{M}$$

where (x_{c}, y_{c}, z_{c}) represents coordinates of each of the total centroids of the pedestrian, (xₖ, yₖ, zₖ) represents coordinates of a k-th body segment of the different body segments, mₖ represents a mass of the k-th body segment of the different body segments, and M represents a total mass of the different body segments.

In an embodiment, the wandering motion trajectories appeared in the different scenes comprise: a multiple oval motion trajectory, a spiral motion trajectory, a snake-like motion trajectory and a Brownian motion trajectory.

In an embodiment, the pedestrian wandering behavior criteria are as follows:

$$Oval . p . = \{ \begin{matrix}cos θ < 0 \\ 4 \geq {N}_{count} \geq 2\end{matrix} \\ Spiral . p . = \{ \begin{matrix}cos θ < 0 \\ 8 \geq {N}_{count} \geq 2\end{matrix} \\ Snake . p . = \{ \begin{matrix}cos θ < 0 \\ {N}_{count} \geq 2\end{matrix} \\ Brown . p . = \{ \begin{matrix}cos θ < 0 \\ {N}_{count} \geq 2\end{matrix}$$

where Oval.p. represents a multiple oval motion trajectory criterion, Spiral.p. represents a spiral motion trajectory criterion, Snake.p. represents a snake motion trajectory criterion, Brown.p. represents a Brownian motion trajectory criterion, θ represents an angle between trajectory vectors of each two frames in a wandering process, and N_{count} represents a threshold of a number of inflection points in the motion trajectory of the pedestrian.

In an embodiment, when there is a back-and-froth motion of the pedestrian, there is at least one inflection point in the motion trajectory of the pedestrian; and
the performing, according to the pedestrian wandering behavior criteria, a wandering behavior recognition on the motion trajectory of the pedestrian to obtain a recognition result includes:
   determining, according to a determining result corresponding to whether a number of the at least one inflection point exceeds a threshold, whether a behavior of the pedestrian is the wandering behavior.

In an embodiment, each of the at least one inflection point is configured to indicate that a change range of a direction angle of a trajectory point in continuous frames of the motion trajectory of the pedestrian exceeds 90 degrees, and a calculation formula for the direction angle of the trajectory point is as follows:

$$cos θ = \frac{\vec{{P}_{t - 1} {P}_{t}} \cdot \vec{{P}_{t} {P}_{t + 1}}}{\vert \vec{{P}_{t - 1} {P}_{t}} \vert \cdot \vert \vec{{P}_{t} {P}_{t + 1}} \vert}$$

where θ represents the direction angle of the trajectory point, Pₜ₋₁ represents a coordinate point of the motion trajectory of the pedestrian at a (t−1)-th time, Pₜ represents a coordinate point of the motion trajectory of the pedestrian at a t-th time, and Pₜ₊₁ represents a coordinate point of the motion trajectory of the pedestrian at a (t−1)-th time.

According to two aspects of the disclosure, the disclosure provides a system for recognizing a wandering behavior of a pedestrian based on a motion trajectory, including:
a pedestrian motion trajectory construction module, configured to acquire motion images of the pedestrian, recognize motion centroids of the pedestrian based on the motion images, and construct the motion trajectory of the pedestrian according to the motion centroids; and
a pedestrian wandering behavior recognition module, configured to perform a wandering behavior recognition on the motion trajectory of the pedestrian according to pedestrian wandering behavior criteria, to obtain a recognition result;
where construction steps of the pedestrian wandering behavior criteria include:
   drawing, according to common wandering behaviors in public places, wandering motion trajectories appeared in different scenes; and
   analyzing the wandering motion trajectories appeared in the different scenes to obtain the pedestrian wandering behavior criteria.

Compared to the related art, the disclosure has the following beneficial effects.
1. According to different wandering motion modes that pedestrians may exhibit in various environments, characteristics of the pedestrian wandering motion trajectories are analyzed. A targeted wandering behavior recognition criterion is proposed according to each wandering motion mode, which improves pertinence of recognizing the wandering behavior of the pedestrian.
2. Motion centroid and motion trajectory information of an object from video or image information is extracted through the computer vision technology, and the obtained data is used for recognizing the wandering behavior and analyzing crowd stability, thereby improve accuracy of recognizing the wandering behavior of the pedestrian.

### BRIEF DESCRIPTION OF DRAWINGS

FIG. 1 illustrates a flowchart of a method for recognizing a wandering behavior of a pedestrian based on a motion trajectory provided by the disclosure.

FIG. 2 illustrates a schematic diagram of wandering trajectories that may exist in different scenes, where (2a) represents a multiple elliptical motion trajectory, (2b) represents a spiral motion trajectory, (2c) represents a snake motion trajectory, and (2d) represents a Brownian motion trajectory.

FIG. 3 illustrates a schematic diagram of inflection points formed in the motion trajectory of the pedestrian.

FIG. 4 illustrates a schematic diagram of an experimental scene in an embodiment, where (4a) represents a physical schematic diagram of the experimental scene, and (4b) represents a virtual schematic diagram of the experimental scene.

FIG. 5 illustrates a schematic diagram of a motion trajectory of total centroids of the pedestrian in the wandering behavior.

### DETAILED DESCRIPTION OF EMBODIMENTS

The disclosure will be described in detail below in combination with the accompanying drawings and specific embodiments. The embodiments are implemented based on the technical scheme of the disclosure, providing a detailed implementation mode and a specific operation process, but the protection scope of the disclosure is not limited to the following embodiments.

### First Embodiment

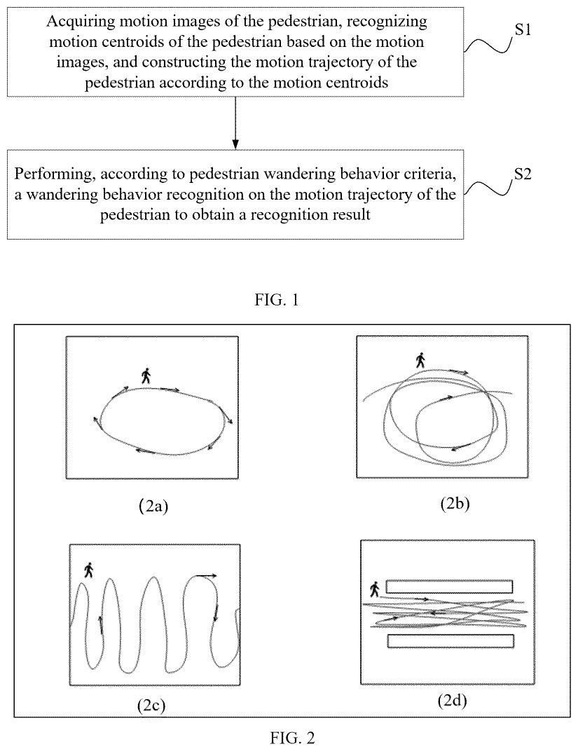

The first embodiment provides a method for recognizing a wandering behavior of a pedestrian based on a motion trajectory, as shown in FIG. 1, which includes the following steps S1 and S2.

In the step S1, motion images of the pedestrian are acquired, based on the motion images, motion centroids of the pedestrian are recognized, and the motion trajectory of the pedestrian is constructed according the motion centroids.

In the first embodiment, a pedestrian falling video is captured and observed in a hall on a first floor of Tongji University Information Center office building as an experimental scene, as shown in (4a) of FIG. 4. A location of a camera is on a right side of a gate, a height of the camera is 1.6 meters (m), and location and site information are shown in (4b) of FIG. 4.

Construction steps of the motion trajectory of the pedestrian are as follows.

Based on the motion images of the pedestrian, key nodes of the pedestrian are obtained to form different body segments, and a centroid of each body segment of the different body is calculated. In the first embodiment, 21 key nodes are used to form 13 body segments, and the 21 key nodes are as follows: a head, a left ear, a right ear, a left eye, a right eye, a nose, a left mouth corner, a right mouth corner, a neck, a left shoulder, a right shoulder, a left elbow, a right elbow, a left wrist, a right wrist, a left hip, a right hip, a left knee, a right knee, a left ankle and a right ankle.

A calculation formula of the centroid of each body segment of the different body segments is as follows:

$${x}_{k} = {x}_{p} {l}_{p} + {x}_{d} {l}_{d} \\ {y}_{k} = {y}_{p} {l}_{p} + {y}_{d} {l}_{d} \\ {z}_{k} = {z}_{p} {l}_{p} + {z}_{d} {l}_{d}$$

where (xₖ, yₖ, zₖ) represents coordinates of the centroid of each body segment of the different body segments, (xₚ, yₚ, zₚ) represents coordinates of a proximal end of each body segment of the different body segments, (x_{d}, y_{d}, z_{d}) represents coordinates of a distal end of each body segment of the different body segments, lₚ represents a weighting coefficient for the coordinates of the proximal end of each body segment of the different body segments, and l_{d} represents a weighting coefficient for the coordinates of the distal end of each body segment of the different body segments.

Total centroids of the pedestrian (i.e., motion centroids of the pedestrian) are calculated by using the centroid of each body segment of the different body segments, and a calculation formula of each of the total centroids of the pedestrian is as follows:

$${x}_{c} = \frac{{\sum }_{k = 1}^{13} {m}_{k} {x}_{k}}{M} \\ {y}_{c} = \frac{{\sum }_{k = 1}^{13} {m}_{k} {y}_{k}}{M} \\ {z}_{c} = \frac{{\sum }_{k = 1}^{13} {m}_{k} {z}_{k}}{M}$$

where (x_{c}, y_{c}, z_{c}) represents coordinates of each of the total centroid of the pedestrian, (xₖ, yₖ, zₖ) represents coordinates of a k-th body segment of the different body segment, mₖ represents a mass of the k-th body segment of the different body segments, and M represents a total mass of the different body segments.

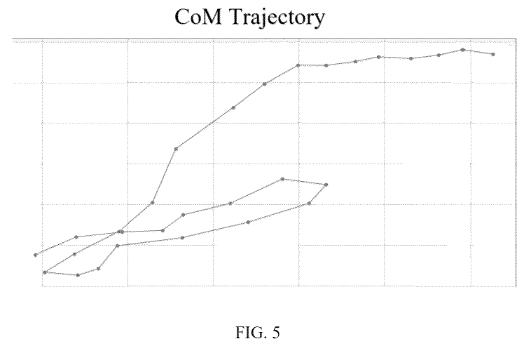

Coordinates of the total centroid of the pedestrian in a period of time are fitted according to a time sequence, thus a motion trajectory of the total centroid of the pedestrian (i.e., motion trajectory of the pedestrian) in the period of time is obtained. In the first embodiment, video information is collected according to a schematic diagram of FIG. 4. A video capture frequency is f=29.97 frames per second (fps), and a resolution of each video frame is 1920*1080 pixels. MATLAB is used to extract video frame images, and an extract frequency as FrameRate is 30. A top-left corner of each video frame image is defined as a coordinate origin, a horizontal direction is an x-axis, where a x-coordinate value represents 1920 pixels, and a vertical direction is a y-axis, where a y-coordinate value represents 1080 pixels. Then, the key nodes of the pedestrian are recognized to obtain a motion trajectory of the total centroid of the pedestrian in the wandering behavior, as shown in FIG. 5. A pedestrian fall process lasts for 10 seconds, and a total of 30 frames of images are extracted.

In the step S2, according to pedestrian wandering behavior criteria, a wandering behavior recognition is performed on the motion trajectory of the pedestrian to obtain a recognition result.

Construction steps of the pedestrian wandering behavior criteria are as follows.

According to common wandering behaviors in public places, wandering motion trajectories appeared in different scenes are drawn, as shown in FIG. 2. The wandering motion trajectories appeared in the different scenes include four types of the wandering motion trajectories: a multiple oval motion trajectory as shown in (2a) of FIG. 2, a spiral motion trajectory as shown (2b) of FIG. 2, a snake-like motion trajectory as shown (2c) of FIG. 2 and a Brownian motion trajectory as shown (2d) of FIG. 2.

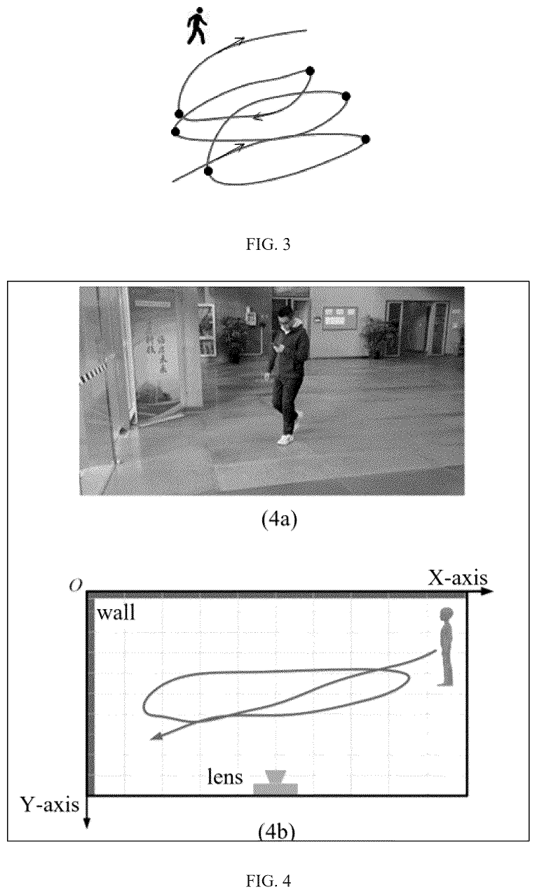

A wandering process of the pedestrian in the public places is often influenced by environmental factors, such as a large number of obstacles or a small range of pedestrian activities. As a result, a range of pedestrian wandering is relatively small, and the motion trajectory of the pedestrian tends to be repetitive. By analyzing the motion trajectory of the pedestrian, whether a pedestrian behavior belongs to the wandering behavior is determined. When the motion trajectory of the pedestrian exhibits repetition, it forms an inflection point, as shown by a black solid dot in FIG. 3. If a change range of a direction angle of a trajectory point in continuous frames of the motion trajectory of the pedestrian exceeds 90 degrees, the trajectory point is recognized as the inflection point. A calculation formula for the direction angle of the trajectory point is as follows:

$$cos θ = \frac{\vec{{P}_{t - 1} {P}_{t}} \cdot \vec{{P}_{t} {P}_{t + 1}}}{\vert \vec{{P}_{t - 1} {P}_{t}} \vert \cdot \vert \vec{{P}_{t} {P}_{t + 1}} \vert}$$

where θ represents the direction angle of the trajectory point, Pₜ₋₁ represents a coordinate point of the motion trajectory of the pedestrian at a (t−1)-th time, Pₜ represents a coordinate point of the motion trajectory of the pedestrian at a t-th time, and Pₜ₊₁ represents a coordinate point of the motion trajectory of the pedestrian at a (t−1)-th time.

By counting a number of the inflection point in the motion trajectory of the pedestrian, if the number exceeds a threshold N_{count}, the motion trajectory of the pedestrian can be determined as the wandering behavior. The pedestrian wandering criteria of the four types of the wandering motion trajectories are shown in Cases 1 to 4.

Case 1, the multiple oval motion trajectory is expressed as follows:

$$Oval . p . = \{ \begin{matrix}cos θ < 0 \\ 4 \geq {N}_{count} \geq 2\end{matrix}$$

Case 2, the spiral motion trajectory is expressed as follows:

$$Spiral . p . = \{ \begin{matrix}cos θ < 0 \\ 8 \geq {N}_{count} \geq 2\end{matrix}$$

Case 3, the snake-like motion trajectory is expressed as follows:

$$Snake . p . = \{ \begin{matrix}cos θ < 0 \\ {N}_{count} \geq 2\end{matrix}$$

Case 4, the Brownian motion trajectory is expressed as follows:

$$Brown . p . = \{ \begin{matrix}cos θ < 0 \\ {N}_{count} \geq 2\end{matrix}$$

A trajectory direction change can be seen visually through the motion trajectory of the total centroid of the pedestrian. According to the pedestrian wandering trajectory criteria, a frame moment of the trajectory direction change can satisfy cos θ<0. And since there are two frame moments of the trajectory direction change, that is, N_{count}≥2, it can be concluded that the wandering behavior of the pedestrian occurs in a video case (i.e., the pedestrian falling video) of the first embodiment.

In order to facilitate visualization of a motion trajectory recognition model, a character η is used to represent the recognition result of the motion trajectory of the pedestrian. When the motion trajectory of the pedestrian is recognized as a wandering trajectory, η=1; otherwise, η=0. In summary, the recognition result of the first embodiment is η=1, that is, there is the wandering behavior.

### Second Embodiment

A system for recognizing a wandering behavior of a pedestrian based on a motion trajectory is provided in the second embodiment, including a pedestrian motion trajectory construction module and a pedestrian wandering behavior recognition module.

The pedestrian motion trajectory construction module is configured to acquire motion images of the pedestrian, recognize motion centroids of the pedestrian based on the motion images, and construct the motion trajectory of the pedestrian according to the motion centroids.

The pedestrian wandering behavior recognition module is configured to perform a wandering behavior recognition on the motion trajectory of the pedestrian according to the pedestrian wandering behavior criteria, to obtain the recognition result.

It should be noted that, each of the pedestrian motion trajectory construction module and the pedestrian wandering behavior recognition module is embodied by software stored in at least one memory and executable by at least one processor.

Construction steps of the pedestrian wandering behavior criteria are as follows.

According to the common wandering behaviors in the public places, the wandering motion trajectories appeared in the different scenes are drawn.

The wandering motion trajectories appeared in the different scenes are analyzed to obtain the pedestrian wandering behavior criteria.

The rest is the same as the first embodiment.

The above provides a detailed description of the specific embodiments of the disclosure. It should be understood that those skilled in the art can make numerous modifications and variations based on the concept of the disclosure without the need for inventive effort. Therefore, any technical solutions that can be obtained by those skilled in the art based on the concept of the disclosure, through logical analysis, reasoning, or limited experimentation, should fall within the scope of protection defined by the claims.

What is claimed is:

1. A method for recognizing a wandering behavior of a pedestrian based on a motion trajectory, comprising:
acquiring motion images of the pedestrian, recognizing motion centroids of the pedestrian based on the motion images, and constructing the motion trajectory of the pedestrian according to the motion centroids; and
performing, according to pedestrian wandering behavior criteria, a wandering behavior recognition on the motion trajectory of the pedestrian to obtain a recognition result;
wherein construction steps of the pedestrian wandering behavior criteria comprise:
drawing, according to common wandering behaviors in public places, wandering motion trajectories appeared in different scenes; and
analyzing the wandering motion trajectories appeared in the different scenes to obtain the pedestrian wandering behavior criteria.

2. The method for recognizing the wandering behavior of the pedestrian based on the motion trajectory as claimed in claim 1, wherein the recognizing motion centroids of the pedestrian based on the motion images, and constructing the motion trajectory of the pedestrian according to the motion centroids comprises:
obtaining, based on the motion images of the pedestrian, key nodes of the pedestrian to form different body segments, and calculating a centroid of each body segment of the different body segments;
calculating total centroids of the pedestrian as the motion centroids of the pedestrian by using the centroid of each body segment of the different body segments; and
fitting coordinates of the total centroids of the pedestrian in a period time according to a time sequence, to thereby obtain a motion trajectory of the total centroids of the pedestrian as the motion trajectory of the pedestrian in the period of time.

3. The method for recognizing the wandering behavior of the pedestrian based on the motion trajectory as claimed in claim 2, wherein the key nodes of the pedestrian comprise: a head, a left ear, a right ear, a left eye, a right eye, a nose, a left mouth corner, a right mouth corner, a neck, a left shoulder, a right shoulder, a left elbow, a right elbow, a left wrist, a right wrist, a left hip, a right hip, a left knee, a right knee, a left ankle and a right ankle.

4. The method for recognizing the wandering behavior of the pedestrian based on the motion trajectory as claimed in claim 2, wherein a calculation formula of the centroid of each body segment of the different body segments is as follows:
$${x}_{k} = {x}_{p} {l}_{p} + {x}_{d} {l}_{d} \\ {y}_{k} = {y}_{p} {l}_{p} + {y}_{d} {l}_{d} \\ {z}_{k} = {z}_{p} {l}_{p} + {z}_{d} {l}_{d}$$
where (xₖ, yₖ, zₖ) represents coordinates of the centroid of each body segment of the different body segments, (xₚ, yₚ, zₚ) represents coordinates of a proximal end of each body segment of the different body segments, (x_{d}, y_{d}, z_{d}) represents coordinates of a distal end of each body segment of the different body segments, lₚ represents a weighting coefficient for the coordinates of the proximal end of each body segment of the different body segments, and l_{d} represents a weighting coefficient for the coordinates of the distal end of each body segment of the different body segments.

5. The method for recognizing the wandering behavior of the pedestrian based on the motion trajectory as claimed in claim 2, wherein a calculation formula of each of the total centroids of the pedestrian is as follows:
$${x}_{c} = \frac{{\sum }_{k = 1}^{13} {m}_{k} {x}_{k}}{M} \\ {y}_{c} = \frac{{\sum }_{k = 1}^{13} {m}_{k} {y}_{k}}{M} \\ {z}_{c} = \frac{{\sum }_{k = 1}^{13} {m}_{k} {z}_{k}}{M}$$
where (x_{c}, y_{c}, z_{c}) represents coordinates of each of the total centroid of the pedestrian, (xₖ, yₖ, zₖ) represents coordinates of a k-th body segment of the different body segments, mₖ represents a mass of the k-th body segment of the different body segments, and M represents a total mass of the different body segments.

6. The method for recognizing the wandering behavior of the pedestrian based on the motion trajectory as claimed in claim 1, wherein the wandering motion trajectories appeared in the different scenes comprise: a multiple oval motion trajectory, a spiral motion trajectory, a snake-like motion trajectory and a Brownian motion trajectory.

7. The method for recognizing the wandering behavior of the pedestrian based on the motion trajectory as claimed in claim 6, wherein the pedestrian wandering behavior criteria are as follows:
$$Oval . p . = \{ \begin{matrix}cos θ < 0 \\ 4 \geq {N}_{count} \geq 2\end{matrix} \\ Spiral . p . = \{ \begin{matrix}cos θ < 0 \\ 8 \geq {N}_{count} \geq 2\end{matrix} \\ Snake . p . = \{ \begin{matrix}cos θ < 0 \\ {N}_{count} \geq 2\end{matrix} \\ Brown . p . = \{ \begin{matrix}cos θ < 0 \\ {N}_{count} \geq 2\end{matrix}$$
where Oval.p. represents a multiple oval motion trajectory criterion, Spiral.p. represents a spiral motion trajectory criterion, Snake.p. represents a snake motion trajectory criterion, Brown.p. represents a Brownian motion trajectory criterion, θ represents an angle between trajectory vectors of each two frames in a wandering process, and N_{count} represents a threshold of a number of inflection points in the motion trajectory of the pedestrian.

8. The method for recognizing the wandering behavior of the pedestrian based on the motion trajectory as claimed in claim 1, wherein when there is a back-and-forth motion of the pedestrian, there is at least one inflection point in the motion trajectory of the pedestrian; and
wherein the performing, according to the pedestrian wandering behavior criteria, a wandering behavior recognition on the motion trajectory of the pedestrian to obtain a recognition result comprises:
determining, according to a determining result corresponding to whether a number of the at least one inflection point exceeds a threshold, whether a behavior of the pedestrian is the wandering behavior.

9. The method for recognizing the wandering behavior of the pedestrian based on the motion trajectory as claimed in claim 8, wherein each of the at least one inflection point is configured to indicate that a change range of a direction angle of a trajectory point in continuous frames of the motion trajectory of the pedestrian exceeds 90 degrees, and a calculation formula for the direction angle of the trajectory point is as follows:
$$cos θ = \frac{\vec{{P}_{t - 1} {P}_{t}} \cdot \vec{{P}_{t} {P}_{t + 1}}}{\vert \vec{{P}_{t - 1} {P}_{t}} \vert \cdot \vert \vec{{P}_{t} {P}_{t + 1}} \vert}$$
where θ represents the direction angle of the trajectory point, Pₜ₋₁ represents a coordinate point of the motion trajectory of the pedestrian at a (t−1)-th time, Pₜ represents a coordinate point of the motion trajectory of the pedestrian at a t-th time, and Pₜ₊₁ represents a coordinate point of the motion trajectory of the pedestrian at a (t−1)-th time.

10. A system for recognizing a wandering behavior of a pedestrian based on a motion trajectory, comprising:
a pedestrian motion trajectory construction module, configured to acquire motion images of the pedestrian, recognize motion centroids of the pedestrian based on the motion images, and construct the motion trajectory of the pedestrian according to the motion centroids; and
a pedestrian wandering behavior recognition module, configured to perform a wandering behavior recognition on the motion trajectory of the pedestrian according to pedestrian wandering behavior criteria, to obtain a recognition result;
wherein construction steps of the pedestrian wandering behavior criterion, comprise:
drawing, according to common wandering behaviors in public places, wandering motion trajectories appeared in different scenes; and
analyzing the wandering motion trajectories appeared in the different scenes to obtain the pedestrian wandering behavior criteria.
